(19) United States
(12) Patent Application Publication
(10) Pub. No.: US 2025/0249863 A1
(43) Pub. Date: Aug. 7, 2025

(54) WHEEL TRAP

(71) Applicant: MOHAMMAD DIKKO LAWAL, READING (GB)

(72) Inventor: MOHAMMAD DIKKO LAWAL, READING (GB)

(21) Appl. No.: 19/042,708

(22) Filed: Jan. 31, 2025

Related U.S. Application Data
(60) Provisional application No. 63/549,452, filed on Feb. 3, 2024.

(51) Int. Cl. B60R 25/09

(52) U.S. Cl. CPC B60R 25/093

(57) ABSTRACT

A wheel trap apparatus includes a first plate assembly and a second plate assembly. A first brace assembly is operably coupled to a first portion of the first plate assembly and operably coupled with a second portion of the first plate assembly. A second brace assembly operably coupled to a first portion of the second plate assembly and operably coupled to a second portion of the second plate. A gearing assembly operable to move the first plate assembly with respect to the second plate assembly so that a first surface of the first plate assembly engages a first portion of a wheel and a second surface of the second plate assembly engages a second portion of a wheel.

### PRIORITY CLAIM

This non-provisional patent application claims the benefit of U.S. Provisional Application No. 63/549,452 filed on Feb. 3, 2024, the entirety of which is incorporated herein by reference.

### FIELD

The present disclosure relates generally to vehicles. More specifically, the present disclosure relates to an apparatus and/or method that prevents a vehicle from moving during an investigative event, such as driving away or fleeing during a traffic stop or similar situation.

### BACKGROUND

There is occasion to detain a vehicle such as an automobile, trailer, truck or other similar type of mode of transportation during traffic stops or other situations. Stopping a vehicle can be a dangerous situation, as it may involve a potential crime, traffic stop or other similar suspect situation. Certain items have been used in an attempt to prevent the vehicle wheel, and therefore the vehicle and its occupants, from rolling even if the driver tries to accelerate the wheel and try to escape the intended stop or potential immobilization. Sometimes these encounters can lead to injuries or even death to the driver, law enforcement, or other third party witnesses.

As such, there is a general need for a solution to many inadvertent injuries or fatalities on the roads pertaining to traffic stops and vehicle pursuits. There is also a general need for an apparatus, a device and/or system that reduces the flight risk of suspect drivers during a traffic stop and that can act as a deterrent from driving away or fleeing a traffic stop.

### SUMMARY

According to an exemplary arrangement, a wheel trap apparatus comprises a first plate assembly and a second plate assembly. A first brace assembly operably coupled to a first portion of the first plate assembly and operably coupled with a second portion of the first plate assembly. A second brace assembly operably coupled to a first portion of the second plate assembly and operably coupled to a second portion of the second plate. A gearing assembly operable to move the first plate assembly with respect to the second plate assembly so that a first surface of the first plate assembly engages a first portion of a wheel and a second surface of the second plate assembly engages a second portion of a wheel.

In an exemplary embodiment, the first brace assembly is pivotally engaged with the first portion of the first plate assembly and pivotally engaged with the second portion of the first plate assembly.

In an exemplary embodiment, the first plate assembly comprises a first curved plate.

In an exemplary embodiment, the first plate assembly comprises a second curve plate.

In an exemplary embodiment, the first brace assembly comprises a telescopic assembly, the telescopic assembly comprising a first bracing member telescopically engaged with a second bracing member.

In an exemplary embodiment, the gearing assembly is operably coupled to the first brace assembly and the second brace assembly. In an exemplary embodiment, the gearing assembly comprises a gearing assembly handle. In an exemplary embodiment, the gearing assembly handle is operable to move the first plate assembly with respect to the second plate assembly.

In an exemplary embodiment, the gearing assembly comprises a worm gearing assembly.

In an exemplary embodiment, the gearing assembly comprises a rack and pinion gearing assembly.

In an exemplary embodiment, the first plate assembly comprises a first curved plate and a second curved plate. In an exemplary embodiment, the first curved plate is pivotally hinged to the second curved plate. In an exemplary embodiment, the first plate assembly comprises a third curved plate. In an exemplary embodiment, the third curved plate comprises a stationary curved plate.

In an exemplary embodiment, the first brace assembly comprises a first male telescoping cylinder engaged with a first female telescoping cylinder. In an exemplary embodiment, the first male telescoping cylinder is spring biased within the first female telescoping cylinder. In an exemplary embodiment, the first brace assembly comprises a second male telescoping cylinder engaged with a second female telescoping cylinder. In an exemplary embodiment, the first brace assembly further comprising a first pushbutton assembly. In an exemplary embodiment, operation of the first pushbutton assembly enables the first male telescoping cylinder to rotate with respect to the first brace assembly.

In an exemplary embodiment, the first plate further comprises a first high friction layer.

In an exemplary embodiment, the first plate assembly further comprises a foldable first plate.

In an exemplary embodiment, the first plate assembly further comprises a first base plate.

In an exemplary embodiment, the first base plate is configured to frictionally engage a surface when a first curved surface of the first plate assembly engages a first portion of a wheel.

In an exemplary embodiment, the first plate assembly comprises a first stabilizing fork and the second plate assembly comprises a second stabilizing fork.

In an exemplary embodiment, the wheel trap apparatus further comprises a handle assembly configured to be operably coupled to the first plate assembly and the second plate assembly.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of a wheel trap, according to an exemplary embodiment;

FIG. 2 illustrates an exploded view of a plate assembly for use with a wheel trap, such as the wheel trap illustrated in FIG. 1;

FIG. 3 illustrates an exploded view of a bracing assembly for use with a wheel trap, such as the wheel trap illustrated in FIG. 1;

FIG. 4 illustrates an exploded view of a gear assembly for use with a wheel trap, such as the wheel trap illustrated in FIG. 1;

FIG. 5 illustrates a wheel trap in a folded or stored condition;

FIG. 6 illustrates a tire trapped within a wheel trap, such as the wheel trap illustrated in FIG. 1;

FIG. 7 illustrates an exploded view of an alternative bracing assembly for use with a wheel trap, such as the wheel trap illustrated in FIG. 1;

FIG. 8 illustrates an exploded view of an alternative gear assembly for use with a wheel trap, such as the wheel trap illustrated in FIG. 1; and

FIG. 9 illustrates an exploded view of another alternative gear assembly for use with a wheel trap, such as the wheel trap illustrated in FIG. 1.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Therefore, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Generally, the present disclosure provides a trapping device, which is easy to use, easy to move, foldable and wherein the operations do not necessarily have to be carried out near the ground surface. An object of this disclosure is that this device should prevent the vehicle wheel from rolling even if the driver tries to accelerate the wheel and try to escape.

In one arrangement, this object is accomplished by using two general concepts. One of those concepts is a brace assembly concept and the other concept is a gear assembly concept. In one preferred arrangement, the brace concept means that curved plates which sustain the driving torque of the vehicle are designed that these transmit the large vehicle thrusts/torques to the road instead of over stressing the structure.

In one preferred arrangement, the gearing assembly means that horizontal brace and brace assembly, grips the wheel firmly and then hooks the structure to the road by means of friction surface at the bottom of the device. The bracing assemblies are each connected to one or more plate of the plate assemblies.

Furthermore, bracing assemblies which are pivotable in part relative to each other are quite suitable for pre-tensioning an object, such as a wheel or tire of a vehicle, using tensioning means. In addition, such a wheel trap device may be arranged for providing leverage, making it possible to transmit a comparatively large tensioning force to the wheel to be immobilized, using a tensioning force. The bracing assembly comprises, in one arrangement, two telescoping or extending arms. And in one arrangement, these arms may in that case each be connected to a plate and to a tensioning element. This makes it possible to generate the tension by exerting a pulling force on the arms.

Furthermore, in an arrangement, the bracing assemblies along with the gearing assembly are arranged for adjusting the tension with which the plates are tensioned against the wheel. This makes it possible to vary the immobilization device independent on the circumstances or the wheel types with which the immobilization device is used.

To adjust the device to different tires or wheels of various automobiles, the adjustment mechanism such as a handle allows the distance adjustment between the first plate assembly and second plate assembly. This enables the device to be adaptable to different wheel and/or tire diameters and different vehicles or automobiles. It also enables the immobilization device to the tire pressure differences or small wheel size differences. For example, different tires might have different curvatures and the disclosed wheel trap assemblies are configured to accommodate many of these different curvature configurations.

In one arrangement, the gear assembly handle not only allows the device to be adapted to various wheels or tires but also allows engaging, tightening and releasing the device from front and behind the wheel or the tire.

In one arrangement, at least certain portions of the bracing assemblies are preferably made of light and strong metal, e.g. an aluminum alloy. This alloy makes it possible to realize an advantageous combination of strength and low weight.

Aluminum and plastic material have the advantage of having a comparatively low specific weight, making it possible to realize a device which is light in weight, thereby enhancing its portability. Stainless steel is also strong and impervious to aggressive substances, however its strength by weight ratio is lower than Aluminum alloy.

As an example, different components of the disclosed wheel trap may either be aluminium alloy or steel. Certain components might need be in steel rather than aluminium in order to prevent fracture especially where there is high tension or force being applied. However, in disclosed embodiments, the combination of these two materials should be within an acceptable weight so that an ordinary person can pickup the wheel trap in one hand.

To realize an adequate adjustment of a desired tension and/or a potential universal applicability with wheels or tires of varying diameter, it is advantageous if the gearing assembly and/or the bracing assemblies comprise a tensioning element which, at least in the tensioned position, is substantially rigid in the longitudinal direction, and locking means for locking the gearing assembly and/or the bracing assemblies in a tensioned condition.

In one arrangement, the device success and ability to stay firm on the ground depends in part on the gripping of tire and in part on the ability of device to grip or hold tightly on the ground which is the road. In one arrangement, this ground-holding ability depends on the weight of the device and the coefficient of friction. Preferably, the weight cannot be increased because an increased weight would decrease the ability to port the device but the coefficient of friction has to be increased. In one arrangement, the means used to increase the coefficient of friction is the usage of elastomeric base material with tungsten carbide pieces embedded on the friction plates which are mounted on the base of the device.

For example, in certain arrangements, the weight of the vehicle that sits on the wheel chocks can creates downward pressure on the wheel trap via the wheel chocks. Thereby creating further entrapment in the wheel trapping device. For example, the weight of vehicle, plus the friction coefficient plus the rubber ground plate plus the friction pattern plust the tire curvatures along with the plastic characteristics will result in a cetain type of stopping power of wheel trap, where upone the tire becomes wedged into the ground.

The present disclosure also relates to a method for trapping a wheel or tire of a vehicle. In one preferred arrangement, the method comprises the step of placing two interconnected plate assemblies in front and behind the wheel respectively to prevent the wheel or tire from rolling. The plate assemblies are gripped against the wheel or tire by a brace mechanism or bracing assemblies. Additionally, in one preferred arrangement, the bracing assemblies enable the first and second plate assemblies to grip the wheel or tire from the rear side thereby reducing the chances of the wheel or tire rolling.

An object of the wheel trap device is to immobilize a vehicle when the vehicle is stopped or is parked or is stationary and/or whilst the driver may still be occupying or not occupying the vehicle. A user (such a user may be a policeman, security personnel or local authority) can install the device on the wheel of a vehicle. This can occur during a traffic stop to prevent the suspect from leaving the scene without authorization e.g. at a roadblock or control point. Should the driver attempt to flee by trying to drive the vehicle away from the scene, the wheel trap device is configured to be wedged within the wheel well of the vehicle, thereby preventing the vehicle from gaining sufficient and/or significant traction, acceleration and/or speed to initiate a vehicle pursuit. In one preferred arrangement of the wheel trap, the wheel trap is configured so that it will anchor the tire using the weight of the vehicle against the high friction plate.

With respect to one arrangement, the wheel trap device comprises a first horizontal brace and a second horizontal brace assembly. These two horizontal brace assemblies are operably coupled to a first plate assembly and a second plate assembly that, in one preferred arrangement, are crescent-shape and facing each other. The two plate assemblies are positioned along the circumference of the tire that grips both the front and rear of the wheel.

In one arrangement, the wheel trap device further comprises a first spring-loaded bracing assembly and a second spring-loaded bracing assembly wherein these two spring-loaded assemblies separately allow the first and second plate assemblies to grip the wheel by traversing the width of the tire tread and hook from the rear side. One advantage of such an alternative structure is that this structure tends to eliminate linear degrees of freedom (i.e., 360 degrees) and impeding or preventing the trapped wheel from inward rotation. In addition, the wheel trap device can also prevent removal of the device from the vehicle's tire. The two horizontal braces which are pivotable about one or more pivot points relative to each other, function as connecting means by which the curved plate assemblies are connected together, and grip occurs due to a tightening or gearing element or assembly that is arranged for tightening the curved plates against the wheel.

In one arrangement, the bottom of the wheel trap device or the bottom of the first plate assembly and second plate assembly which are in contact with the road surface may be lined with one or more high friction plates. As just one example, in one arrangement, the high friction plates comprise an elastomer wherein the elastomer may be impregnated with a high friction type material, such as tungsten carbide. This tends to enhance the friction coefficient, leading to a better contact and gaining firm stability of the device on the road.

The wheel trap device is designed to be primarily used as a vehicle detainment and immobilization device intended to be used by the police or law-enforcement agencies, security personal for temporary detainment of a suspect vehicle. However, as those of ordinary skill in the art will recognize, alternative and supplemental uses may also be achieved.

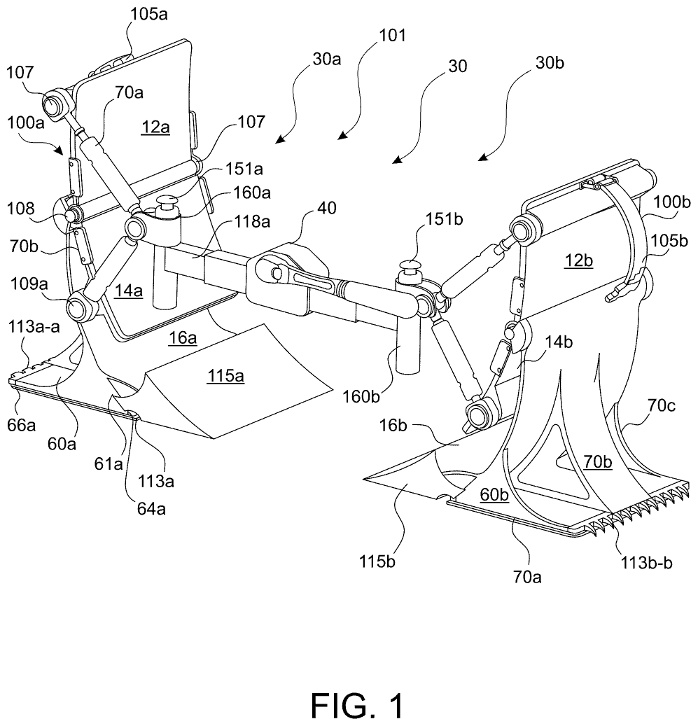

Turning now to the figures, FIG. 1 is a perspective view of a wheel trap apparatus 101. In this illustrated arrangement, the wheel trap apparatus 101 comprises a plurality of plate assemblies. For example, as illustrated, the wheel trap apparatus 101 comprises a first plate assembly 100a and a second base assembly 100b. In one preferred arrangement, the first assembly 100a and the second assembly 100b are similarly configured and/or structured. That is, in one preferred arrangement, the first plate assembly 100a and the second base assembly 100b have substantially similar components having substantially similar performance characteristics. However, as those of ordinary skill in the art will recognize, alternative plate assembly arrangements may be utilized as well.

In this illustrated arrangement, the first plate assembly 100a is configured to comprise a plurality of plates. For example, as illustrated in this preferred arrangement, this first plate assembly 100a comprises a first plate 12a and a second plate 14a. In this illustrated arrangement, when viewed in a configured state for employment, the first plate 12a may be represented as a top most plate and the second plate 14a may be represented as a bottom plate. As one example, the first plate 12a and the second plate 14a are operably coupled to one another by a hinge. This hinge may take many forms however, in this illustrated example, the hinge takes the form of a plurality of pivot rods.

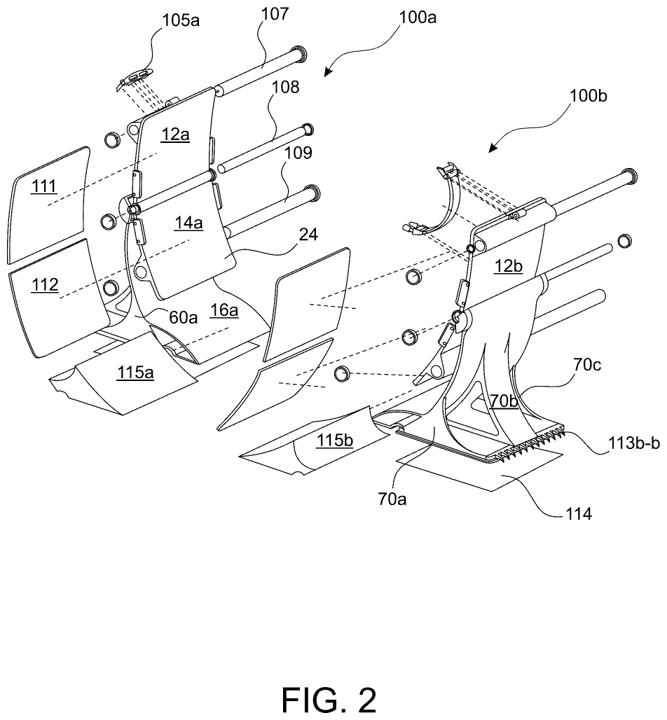

For example, as illustrated, the first plate 12a and the second plate 12b are operably coupled to one another by a hinge in the form of a first pivot rod 107, a second pivot cylinder 108, and a third pivot rod 109 as illustrated in FIG. 2. For example, FIG. 2 illustrates an exploded view of a plate assembly for use with a wheel trap, such as the wheel trap 101 illustrated in FIG. 1. However, as those of ordinary skill in the art will recognize, alternative plate assembly and pivot rod arrangements may be utilized as well. As just one example, in one arrangement, more than three pivot rods and/or less than three pivot rods may be utilized to operably couple the first plate and the second plate.

Returning to FIG. 1, in one preferred arrangement, these hinges 107, 108, 109 are operable to allow the first plate 12a to rotate with respect to the second plate 14a. In addition, these hinges 107, 108, and 109 allow the second plate 14a to rotate with respect to the first plate 12a. Rotation of the first plate 12a with respect to the second plate 14a and visa versa allows for the first plate 12a assembly to be configured in different arrangements and this can lead to certain advantages. For example, rotation of the first plate 12a with respect to the second plate 14a and visa versa allows for the first plate 12a assembly to properly capture or retain different or varying circumferences of different or varying wheels and/or tire sizes.

In one preferred arrangement, the first plate assembly 100a comprises a first curved plate 12a. Similarly, in one preferred arrangement, the second plate assembly 100b comprises a second curved plate 12b. In one preferred arrangement, the curvature of the first curved plate 12a is substantially similar to the curvature of the second curved plate 12b. This first plate assembly 100a may comprise a multi-component curved plate. The first or upper plate and second or lower curved plates 12a and 14a, respectively are pivotably engaged to one another by way of these hinges 107, 108, 109. The hinges 107, 108, 109 may comprise substantially similar hinges. However, as those of ordinary skill in the art will recognize, alternative hinge arrangements may be utilized as well.

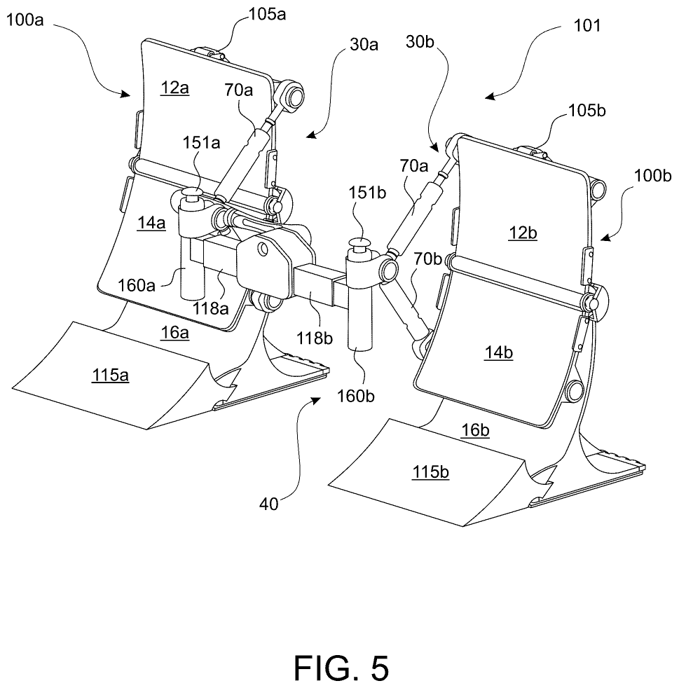

In one preferred arrangement, the first plate assembly 100a is operably coupled to the second plate assembly 100b by way of a bracing structure 30. As illustrated in this illustrated arrangement, the bracing structure 30 is positioned in between the first plate assembly 100a and the second assembly 100b. As in this illustrated embodiment, the bracing structure 30 comprises a first bracing assembly 30a and a second bracing assembly 30b. As described and illustrated in detail herein, the first bracing assembly 30a and second bracing assembly 30b allows the wheel trap 101 to be configured such that the wheel trap 101 is configured to comprise a folded or compact form. Such a compact wheel trap 101 can be beneficial for certain events and situations, such as for wheel trap transport and/or wheel trap storage. Such a folded or compact form of the wheel trap 101 is explained in greater detail herein, particularly with respect to FIG. 5.

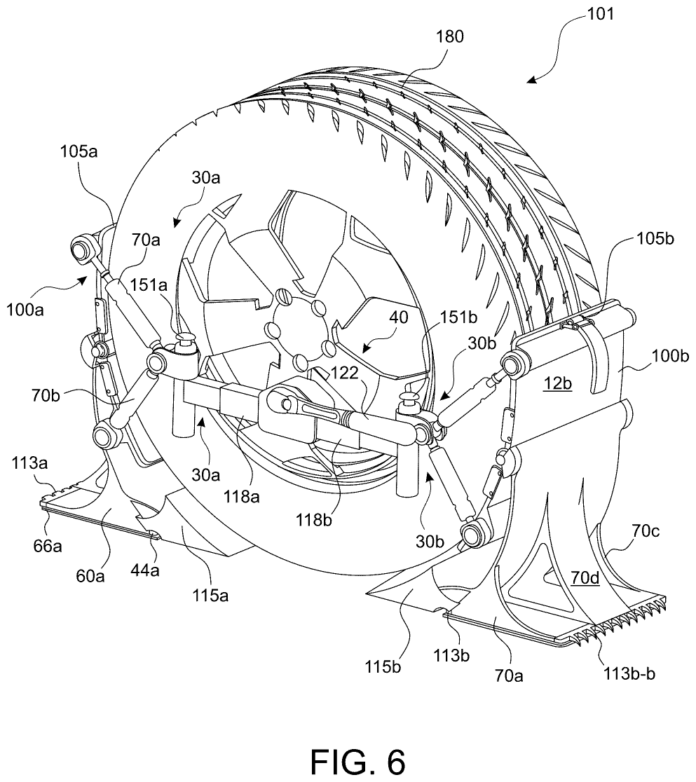

FIG. 2 illustrates an exploded view of a first plate assembly 100a for use with a wheel trap, such as the wheel trap 101 illustrated in FIG. 1. As illustrated in FIG. 2, the plate assembly 100a comprises a multi-component plate assembly. In one preferred arrangement, these plates may comprise curved plates. In one preferred arrangement, this multi-plate assembly comprises a first or an upper curved plate 12a and a second or lower curved plate 14a. The upper curved plate 12a performs certain important features such as to help to ensure extra gripping of the tire as illustrated in FIG. 1. The lower curved plate 14a is the lower part of the curved plate which is primarily in contact with a tire when the wheel trap 1 is in use. For example, FIG. 6 illustrates a tire trapped within a wheel trap, such as the wheel trap illustrated in FIG. 1.

FIG. 2 also illustrates that the curved plate comprises an upper or first overlay 111. In one preferred arrangement, the upper or first overlay 111 may comprise an overlay such as a high friction overlay. This upper or first overlay 111 is positioned along a surface of the upper curved plate or the first curved plate 12a of the first plate assembly 100a. In a similar manner, a lower overlay or second overlay 112 may comprise a high friction overlay. In such a situation, such high friction overlay is positioned over a surface of the lower or second curved plate 14a. Such an arrangement may result in several wheel trap advantages. For example, one advantage of such a wheel trap configuration is that the upper rubberized overlay 111 and the lower rubberized overlays 112 are used to protect certain metallic component parts of the automobile when the wheel trap 101 is utlilzed for vehicle immobilization.

In addition, these overlays may also be used to reduce potential damage to the automobile and help to ensure a frictional grip of the tire by the wheel trap 101. Like the configurations of the first plate 12a and the second plate 14a, the first overlay 111 and the second overlay 112 are configured in a curved manner. In one arrangement, the curved manner of the first overlay 111 is substantially the same as the curved manner of the second overlay 112.

With such a curved configuration, the curved nature of the first overlay and second overlay 111, 112 allow a more secured fit to the curved nature of the first and second plates 12a, 14a.

Referring now to FIGS. 1 and 2, in one arrangement, the first plate assembly 100a comprises a base structure 60a. In addition, the second plate assembly 100b comprises a similar base structure. This base structure 60a comprises a vertically extending support structure. In this illustrated embodiment, the vertically extending support structure 60a comprises a curved vertically extending support structure that is configured, in use, to support at least in part the second plate 14a. This vertically extending support structure 60a extends from a first support structure end 64a to a second support structure end 66a. The vertically extending support structure 60b of the second plate assembly 100b is similarly configured. However, as those of ordinary skill in the art will recognize, different support structure configurations may also be utilized.

At this first end 64a, and as illustrated in FIG. 1, the vertically extending support structure 60a is operably coupled to a first choke 115a. In one preferred arrangement, this first choke 115a comprises a rubberized choke and may be removably coupled to the first end 64a of the vertically extending support structure 60a. In a similar arrangement, the second plate assembly 100b comprises a second choke 115b.

In one arrangement, the first vertically extending support structure 60a is supported on a first base member and may be supported on this first base member by a plurality of support members. As can be seen from the vertically extending support structure of the second plate 100b illustrated in FIGS. 1 and 2, the vertically extending support structure is supported on a base member by three vertically extending support members 70a, b, c. Although three vertically extending support members 70a, b, c are shown, those of ordinary skill in the art will recognize alternative support member mechanisms may be utilized as well. As just one example, more or less than three support members may be used in different arrangements.

### Stabilizing Forks

In a preferred arrangement, the wheel trap apparatus 101 includes a first plate assembly 100a that comprises a first stabilizing fork 113a. In this illustrated arrangement, the first stablilizing fork 113a extends from the first end 66a of the first support structure 60a. Similarly, as illustrated in FIG. 1, the second plate assembly 100b comprises a second stabilizing fork 113b. In this configuration, the first stabilizing fork 113a is configured to extend from a bottom portion of the first plate assembly 100a. More specifically, the first stabilizing fork 113a is configured to extend from a bottom portion of the third plate 16a of the first plate assembly 100a. The second plate assembly 100b may comprise a similar stabilizing fork arrangement 113b. As those of ordinary skill in the art will recognize, alternative stabilizing fork configurations may be utilized.

This first stabilizing fork 113 may be configured to provide several advantages. For example, the first stabilizing fork 113 may be configured to help to ensure an extra grip of the wheel trap 101 to a surface, such as a surface of a road. In one preferred arrangement, the first stabilizing fork 113a may be provided with a stabilizing fork cover that tends to shield direct access to the forks.

In one preferred arrangement, the first plate assembly 100a may comprise a second stabilizing fork 113a-a. For example, as illustrated in FIGS. 1 and 2, the first stabilizing fork 113a extends from a first end of the base unit 64a and the second stabilizing fork 113a-a extends from an opposite end or a second end 66a of the base unit. The second plate assembly 100b may comprise a similar stabilizing fork arrangement 113b.

These stabilizing forks 113a, b due to their pointed structure and associated grip can play an important part in the device functionality. The first and second stabilizing forks 113a, b can interlock into the road frictional surface and may achieve an adequate frictional bond between the wheel trap 101 and the road. The force required to bond the stabilizing forks 113a, b and the road is provided by two factors. One is the weight of the wheel trapping device 101 and second is the torque provided by the automobile which translates into the normal force and thus reinforces the group of the wheel trapping device 101 with the road.

In one arrangement, the stabilizing forks 113a, b comprise a plurality of fork or claw like structures. These structures are mechanically structured to enhance the gripping action of the plate assemblies 100a, 100b along an upper surface, such as an upper surfaced of a street or road. In one alternative arrangement, these fork or claw like structures may be even spaced along an attachment plate. This attachment plate may be secured to the base of the plate assembly. In one arrangement, a protective cover may be used to extend or may be secured to the attachment plate. The protective cover can act as a deterrent to prevent unintentional or accidental engagement with the fork like structures.

### Plate Base

As illustrated in FIG. 2, the lower curved plate or the third curve plate 16a extends from a first plate base 60a. This first plate base 60a resides on a rubber overlay bottom or a stabilizing thread plate 114. This thread plate 114 is releasably secured to the base of the lower curved plate and is used to reduce potential damage to the automobile. This plate 114 also helps to ensure a frictional grip of the tire by the wheel trap assembly.

In one preferred arrangement, the first plate 114 may further comprise a stabilizing thread plate. For example, such a stabilizing thread plate may include a plurality of different types of thread patterns. These different thread patterns allow the stabilizing thread plate 114 to generate a certain amount of friction when the stabilizing thread plate extends along a surface, such as the surface of a street.

The stabilizing thread projections serve the purpose of increasing the grip of the wheel trap 101 with an engaging surface, such as a surface of a street or a road. The purpose of these treads is to make the surface rough and engage with the road irregularities and thus ensure positive grip of the device with the road.

In one preferred arrangement thread projection arrangement, two types of treads may be used. One of these types of threads comprise straight treads which cover approximately 80% of the area of the cover plate. These are the main threads which engage the road surface. The other type of threads may comprise cylindrical treads, which function to lock the start of any slip instance. Therefore, together these treads can be implemented to ensure an adequate gripping of the device. However, as those of ordinary skill in the art will recognize, alternative tread arrangements may also be used. For example, more than two types of treads may be used and these alternative threads may use the same or different geometrical tread patterns and shapes.

### Bracing Assemblies

In addition, and as can be seen from FIG. 1, the wheel trap 101 also comprises a first bracing assembly 30a and a second bracing assembly 30b. In one preferred arrangement, the first bracing assembly 30a and the second assembly 30b are similarly constructed. However, as those of ordinary skill in the art will recognize, alternative brace assembly configuration and structures may also be utilized.

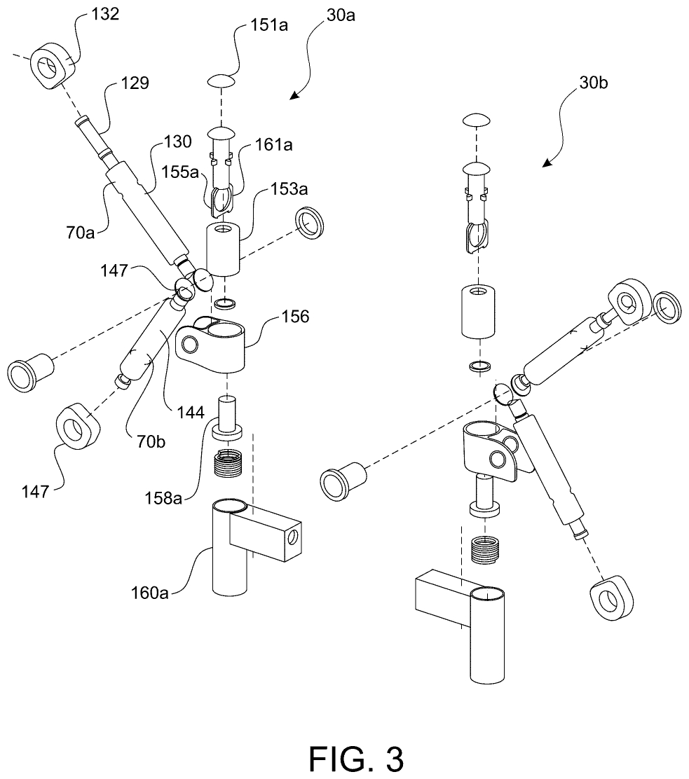

In one arrangement, the first bracing assembly 30a comprises a first telescopic assembly 70a and a second telescopic assembly 70b. For example, as can be seen from FIG. 3, the first telescopic assembly 70a may comprise a first bracing member 129 that is telescopically engaged with a second bracing member 130. In one preferred arrangement, the first telescopic assembly 70a may comprise a gas spring assembly.

The first bracing assembly 30a further comprises a second telescopic assembly 70b. For example, the second telescopic assembly 70b may comprise a first bracing member 144. (see e.g., FIG. 3). In one preferred arrangement, the second telescopic assembly 70 may comprise a gas spring assembly.

### First Telescopic Assembly 70a

As illustrated in FIG. 1, in one arrangement, this first bracing assembly 30a is pivotally engaged with a first portion of the first plate 12a. For example, as illustrated in FIG. 1, the first bracing assembly 30a is pivotally engaged to a top portion of the first plate assembly 100a. More specifically, the first bracing assembly 30a is pivotally engaged with a top portion of the first plate 12a of the first plate assembly 100a.

In one arrangement, the first telescopic assembly 70a of the first brace assembly 30a is operably coupled to the first plate assembly 100a. The first telescopic assembly 70a is configured to adjust its overall length to account for various positions of the first plate 12a of the first plate assembly 100a. These various positions of the first plate 12a allow for the wheel trap 101 to be used to secure wheels and tires of various sizes.

### Second Telescopic Assembly

Similarly, a second portion of the first bracing assembly 30a is operably coupled to the second plate 14a of the first plate assembly 100a by way of the second telescopic assembly 70b. The second telescopic assembly 70b is configured to adjust its overall length to account for various positions of the second plate 14a of the first plate assembly 100a. These various positions of the second plate 14a allow for the wheel trap 101 to be used to secure wheels and tires of various sizes.

### First Telescopic Assembly

FIG. 3 illustrates an exploded view of a first bracing assembly 30a for use with a wheel trap, such as the wheel trap 101 illustrated in FIG. 1. In one preferred arrangement, the second bracing assembly 30b illustrated in FIG. 1 is similar in construction to the first bracing assembly 30a and comprises similar bracing assembly components as illustrated in FIG. 3. As such, for ease of reference and discussions, details for the first bracing assembly 30a will be provided with reference to FIGS. 1 and 3.

As illustrated in FIGS. 1 and 3, the first bracing assembly 30a comprises a first telescopic assembly 70a. In one preferred arrangement, this first telescopic assembly 70a comprises a first telescoping arm 129 and a second telescoping arm 130. The first telescoping arm 129 is provided with various connecting components that allow the first telescoping arm 129 to be operably coupled to the first plate 12a of the first plate assembly 100a as illustrated in FIGS. 1, 5 and 6. As just one example, these various connecting components may comprise a hinge or pivot 132. As those of ordinary skill in the art will recognize, alternative connecting component arrangements may be utilized as well.

Similarly, the second telescoping arm 130 is provided with various connecting components that allow the second telescoping arm 130 to be operably coupled to the upper housing 153 as illustrated in FIG. 3. As just one example, these various connecting components may comprise an o ring 147. As those of ordinary skill in the art will recognize, alternative connecting component arrangements may be utilized as well.

In one preferred arrangement, the first telescoping arm 129 and the second telescoping arm 130 are mechanically configured so that they operate together to provide the necessary horizontal force to the first plate assembly 100a. In one preferred arrangement, the first telescopic arm 129 operates as a male cyinder in that it receives the second telescopic arm 130 which operates as a female cylinder. In this manner, the male cylinder 129 is spring biased within the female cylinder 130 by way of a compression spring. However, as those of ordinary skill in the relevant art will recognize, alternative telecoping arm arrangements may be utilized as well.

### Second Telescoping Arm Assembly

As illustrated in FIG. 3, the first bracing assembly 30a also comprises a second telescopic assembly 70b. In one preferred arrangement, this second telescopic assembly 70b comprises a first telescoping arm 144. The first telescoping arm 144 is provided with various connecting components that allow the first telescoping arm 144 to be operably coupled to the second plate 14a of the first plate assembly 100a as illustrated in FIGS. 1, 5 and 6. As just one example, these various connecting components may comprise a hinge or pivot 147. As those of ordinary skill in the art will recognize, alternative connecting component arrangements may be utilized as well.

Similarly, the first telescoping arm 144 is provided with various connecting components that allow the first telescoping arm 144 to be operably coupled to the upper housing 153 as illustrated in FIG. 3. As just one example, these various connecting components may comprise an o ring 147. As those of ordinary skill in the art will recognize, alternative connecting component arrangements may be utilized as well.

### Alternative Bracing Assembly

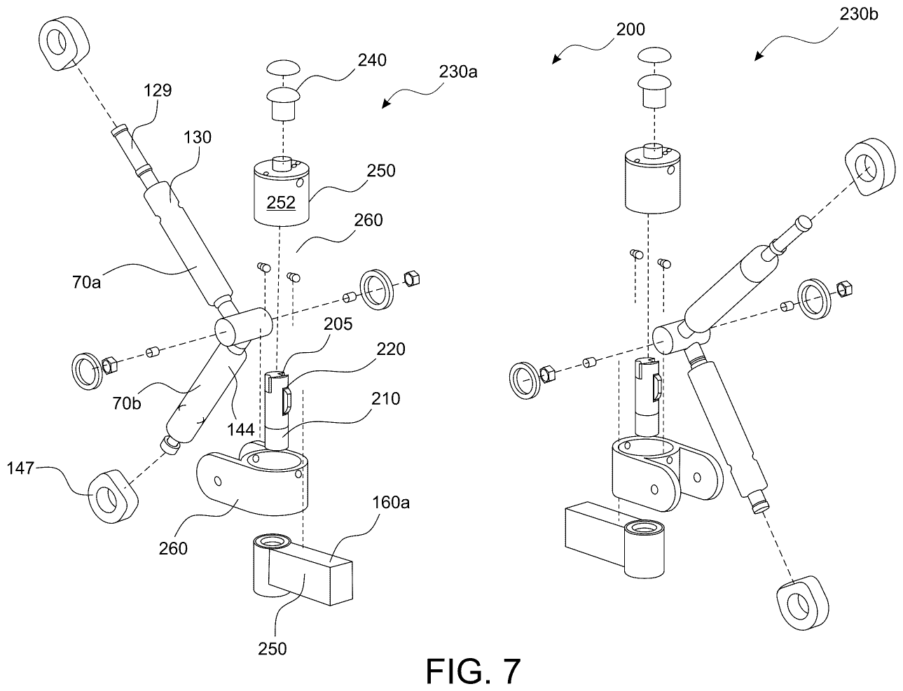

FIG. 7 illustrates an exploded view of an alternative bracing assembly 200 for use with a wheel trap, such as the wheel trap 101 illustrated in FIG. 1. As illustrated, this alternative bracing assembly 200 enables the upper and lower parts of the horizontal brace assembly joined together to rotate 90 degrees relative to each other when a button is pressed. This relative rotation is important to fold or compress and unfold or uncompress the wheel trap 101.

The illustrated second bracing assembly 200 contains certain similar components as the first bracing assembly 30 illustrated in FIGS. 1 and 3. As just one example, the second bracing assembly 200 comprises a first 230a and a second 230b which are substantially similarly configured.

In this illustrated bracing assembly arrangement 200, a spring-loaded push-to-rotate mechanism, draws inspiration from certain technology areas, such as a push latch system. An important feature of this illustrated bracing assembly 200 comprises a first bracing assembly 230a comprising certain similar features as the first bracing assembly 30a illustrated in FIG. 3. For example, certain common elements provided by the first bracing assembly 30a illustrated in FIG. 3 and the first bracing assembly 230a illustrated in FIG. 7 include at least the following: first telescopic assembly 70a; second telescopic assembly 70b; first telescoping arm 129; second bracing member 130; hinge or pivot 132; first telescoping arm 144; hinge or pivot 147; and yoke connection 156.

In addition, the first bracing assembly comprises the following components which are operably configured: a rotating shaft 210, a spring-loaded plunger 230, a cam mechanism 220 with a plurality of helical grooves 225, and a plurality of stop detents 260. In addition, the illustrated bracing assembly 200 further comprises a human interface component for enabling the bracing structure 200 to fold and/or collapse into a stowable condition. As just one example, such a human interface component may comprise a button actuator 240. However, as those of ordinary skill in the art will recognize, alternative human interface components may be utilized as well. The second bracing assembly 230b acts in a substantially similar manner as the first bracing assembly 230a. As such, in this illustrated arrangement, the second bracing assembly 230b comprises substantially similar components parts as the first bracing assembly 230a.

### Operation of Second Bracing Assembly 200

This alternative bracing mechanism 200 operates as follows. The mechanism works as follows: When the button actuator 240 is activated or in one arrangement, where a top portion of the button actuator 240 is pushed by an operator of the wheel trap 101, the button actuator 240 compresses a spring 252 that is contained in the spring-loaded plunger 250. Compression of this spring 252 disengages a locking or stop detent 260. In one arrangement, the locking or stop detent 260 holds a top part of the horizontal brace assembly in its initial position.

This spring compression action engages the cam mechanism 220. In one preferred arrangement, the cam mechanism 220 comprises a helical groove or helical ramp 205. Therefore, as the button actuator 240 is pressed further, a linear motion of the spring-loaded plunger 250 is converted into rotational motion through the cam mechanism 220. This rotational motion of the cam mechanism 220 causes the rotating shaft 210 to rotate precisely 90 degrees. At the end of this motion, the spring-loaded plunger 250 locks into a second stop detent 260, securing the top part of the assembly in its new position.

When the button actuator 240 is subsequently depressed, the process is reversed. The spring 205 within the spring loaded pounger 250 compresses to release the lock, and the cam mechanism 220 ensures that the top part of the horizontal brace assembly so that the horizontal brace assembly may now rotate back to its original position. The alignment of the plurality of detents 260 and cam mechanism 220 help to ensures accurate and repeatable motion. This mechanism 200 provides rotation stability at each position and is ideal for wheel trapper 101 folding and unfoling, requiring a compact, reliable, and user-friendly rotational motion control.

### Sliding Housing

In one preferred arrangement, and now referring to FIGS. 1, 3 and 5, the first bracing assembly 30a further comprises a first sliding housing 160a. The alternative first bracing assembly 230a illustrated in FIG. 7 comprises a similar feature in horizontal brace assembly 250.

This first sliding housing 160a comprises a spring biased push button 151a. Once the spring biased push button 151a is activated, it releases the sliding housing 160a to slide along a connecting gearing cylinder. In this manner, the first sliding housing 160a can slide from a first sliding housing position as illustrated in FIG. 1 to a second sliding housing position shown as illustrated in FIG. 5. As can be seen from FIG. 5, in the second sliding housing position, the first sliding housing 160a has been moved from a position near the first plate assembly 100a to a position near the gear assembly housing 127.

Similarly, the second bracing assembly 30b is configured substantially identical to the first bracing assembly 30a by comprising a second sliding housing 160b. Specifically, the second bracing assembly 30b comprises a second sliding housing 160b which operates in a similar manner as the first sliding housing 160a. Therefore, and in a similar manner, the second sliding housing 160b of the second bracing assembly 30b can also be moved from the extended position as illustrated in FIG. 1 to a retracted position as illustrated in FIG. 5. Movement of the first and second sliding housings 160a, b allows the wheel trap 101 to achieve the folded position as illustrated in FIG. 5.

### Folding

In addition to its function of transferring force to the first plate assembly 100a, the horizontal bracing assembly 30 of the wheel trap 101 also serves a secondary purpose in the form of an innovative folding mechanism. This feature enables the wheel trap 101 to be configured to be stored in a confined space, such a the trunk of a police vehicle when not in use, making wheel trap 101 portable and convenient.

In one preferred arrangement, to engage this folding mechanism of the trap 101, and referring to FIGS. 1 and 3, the user presses the push buttons 151a, b located at the top of the sliding housings 160a, b. This action causes the upper housings 153a, b to move downwards. This downward movement of the upper housing a 153a, b causes the disengagement of the pusher lower housings 158a, b through the yoke connections 156a, b. As a result, the sliding housings 160a, b can then be rotated 90 degrees around the central axis of the wheel trap 101, allowing for compact storage.

### FIG. 5

This folded position of the wheel trap 101 is illustrated in FIG. 5. In this folded position, and comparing the unfolded wheel trap position as illustrated in FIG. 1, the first plate assembly 100a resides adjacent to the second plate assembly 100b. As can be seen, the two sliding housing portions 160a, b have been moved or have been slid along the horizontal cylinder to now reside immediately adjacent the housing of the gearing assembly 30. Similarly, the second housing portion 160b has also been moved or has been moved long the horizontal cylinder so that now this second housing portion 160b also resides adjacent the housing of the gearing assembly. In this folded position, a user can now grasp the handle 105 and port the wheel trap 101 from location to next location.

### Puller Cylinder 61

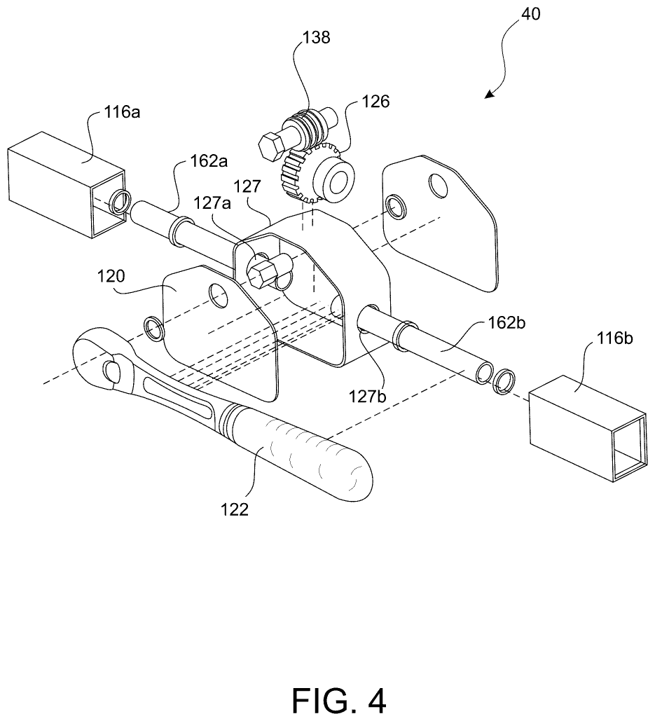

Returning to FIG. 3, the bracing assembly 30a, b further comprises a first and a second pusher rod 161a, b. The pusher rods 161a, b are configured to allow to pass through the first and second upper housings 153a, b respectively. For example, with respect to the first bracing assembly 30a, when the first push button 15a is pressed to initiate the folding process, the foldability holder ring 155a disengages from the puller cylinder 161. By this action, the puller cylinder 161 is now free to slide out of the upper sliding housing 160 until it is stopped by an axial stop provided along an exteriod surface of the threaded pusher 162a (See FIG. 4). The second bracing assembly 30b acts in a substantially similar manner as the the first bracing assembly 30a. This folding activation process helps to ensure that the wheel trap 101 can be stored in a compact form, ready for convenient transport or deployment as needed.

### Gear Assembly

FIG. 4 illustrates an exploded view of a gear assembly 40 for use with a wheel trap, such as the wheel trap 101 illustrated in FIG. 1. As illustrated in FIG. 4, this gearing assembly 40 comprises a gearing assembly box 127 that houses or contains various gearing components of the gearing assembly 40, such as the spiral pinion 138 and the spiral gear 126. The gearing assembly 40 also comprises a gripping handle 122 that a user can manipulate to adjust a distance between the first plate assembly 100a and the second plate assembly 100b towards one another so as to eventually grip the tire of the vehicle.

Referring now to FIGS. 1 and 4, to adjust a distance between the first plate assembly 100a and the second plate assembly 100b, the wheel trap 101 further utilizes a gearing assembly 40. This gearing assembly 40 is operable to move the first plate assembly 100a with respect to the second plate assembly 100b. In a preferred arrangement, a gearing assembly 40 is operable to move the first plate assembly 100a with respect to the second plate 100b so that a first surface 14a of the first plate assembly 100a engages a first portion of a wheel or a tire.

As just one example, the gearing assembly 40 is operable to move the first plate assembly 100a with respect to the second plate 100b so that a first surface 14 of the first plate 12a of the first assembly 100a engages a first portion of a wheel or a tire. As just another example, the gearing assembly 40 is operable to move the first plate assembly 100a with respect to the second plate 100b so that a first surface 14 of the second plate 14a of the first assembly 101 engages a first portion of a wheel or a tire.

Similarly, a second surface 24 of the second plate 14a engages a second portion of a wheel or a tire. By moving the first plate assembly 100a closer to the second plate assembly 100b and allowing the surfaces 14, 24 of the first and second plate 12a, 14a to engage an outer surface of a tire or wheel, the wheel trap 101 can trap or immobilize a wheel, thereby preventing movement of a vehicle that a user wishes to contain.

In such an arrangement, the gearing assembly 40 may comprise a gearing assembly handle 122. Such a gearing assembly handle 122 may be operable to move the first plate assembly 100a with respect to the second plate assembly 100b. For example, rotating the gearing assembly handle 122 in a desired direction (e.g., in a clockwise direction) may move the first plate assembly 100a away from the second plate assembly 100b. Alternatively, rotating the gearing assembly handle 122 in another, different desired direction (e.g., in a counter-clockwise direction) may move the second plate assembly 100b away from the first plate assembly 100a. Alternatively, rotating the gearing assembly handle 122 in a counterclockwise direction may move the first plate 100a in a direction towards the second plate 100b.

The gearing assembly 40 may take various forms. For example, in one arrangement, the gearing assembly 40 comprises a worm gearing assembly. For example, the gearing assembly 40 may comprise a spiral gear 126 that is configured to be used to transfer torque from the spiral pinion 138 to two sets of threaded pusher 162a, b. In FIG. 4 both the first threaded shaft pusher 162a and the second threaded pusher 162b are illustrated. In one preferred arrangement, the second threaded pusher 162b is configured similarly to the first threaded pusher 162a. Such a second threaded shaft 162b is illustrated in FIGS. 1 and 5.

In an assembled state as illustrated in FIGS. 1, 2, 3, and 5, the first threaded shaft 162a is configured to extend through a first aperture 127 a defined by the gearing assembly box 127. Similarly, the second threaded shaft assembly 162b is configured to extend through a second aperture 127b defined by the gearing assembly box 127. In an assembled state, the gearing assembly utilizes a cover plate 120 to enclose the contents of the gearing assembly box 127. In one preferred arrangement, the cover plate 120 may define an aperture for receiving at least a portion of the handle 122. In this manner, a user manipulating the handle 122 can operate the gear assembly 40 so as to expand and contract the wheel trap 101 as herein described.

In one preferred arrangement, the spiral gear 126 is used to transfer torque from the spiral pinion 138 to both the first and second threaded shafts 162a, 162b by way of linear motion. In one preferred arrangement, the spiral pinion 138 is configured to transfer torque from the handle 122 to both the first threaded sleeve 162a and the second threaded sleeve 162b. The first and second threaded sleeves 162a, b are coupled to the spiral gear 126 and then take the rotational motion of the spiral gear 126 and translates this rotational movement to linear movement of the first and the second female slider boxes 116a, b, respectively. As the first and second female slider boxes 116a, b move outward and away from the gearing assembly box 127, they transfer this linear motion. More specifically, the first and second female slider boxes 116a, b transfer this linear motion to the first plate assembly 100a and the second plate assembly 100b, respectively.

As such, the gearing assembly 40 converts the user's rotating force enabled by rotation of the handle 122 into a horizontal force, which is then transmitted to the first and second bracing assemblies 30a, b. In one preferred arrangement, when the user rotates the handle 122 in the clockwise direction, the resulting torque is transferred to the spiral pinion 138 which is threadely engaged with the spiral gear 126. Because of this threaded engagement, rotation of the spiral pinion 138 propels the spiral gear 126 to rotate as well. In one preferred arrangement, this spiral gear 126 is operably coupled to both a first or a left threaded pusher 162a and a second or a right male threaded pusher 162b, using left and right-hand threads respectively.

As the user continues to rotate the handle 122, both the left and right-side cylinders 162a, 162b are gradually pulled towards the gearing assembly housing 127, which comprises the gear assembly box 127 and respective gear assembly cover plate 120. Conversely, when the handle 122 is rotated in the counterclockwise direction, the left and right-side cylinders 162a, 162b are released and move away from the gear assembly housing 127. In one preferred arrangement, to prevent unintended operation or tampering of the wheel trap 101, a handle lock is provided on the handle 122. This ensures that when the wheel trap 101 is deployed, the user can rotate the handle 122 in a safe and controlled manner.

### Gearing Assembly Operation

Referring now to FIGS. 1, 4, 5, features of an exemplary gearing assembly 40 are illustrated. In various arrangements, alternative gearing assembly 40 arrangements may be utilized. For example, the gearing assembly 40 can be a hydraulic or spur gear based. However, worm gear mechanism may enjoy certain advantages over a spur gears or hydraulic mechanism, including lower cost, fewer issues with reciprocating loads, and self-locking feature. Those of ordinary skill in the art will recognize alternative mechanisms may also be used. For example, servomotor and similar electronic based drive mechanisms may also be utilized.

Returning to FIG. 4, when the gearing assembly handle or main operating handle 122 rotates in a first desired direction (i.e., a clockwise direction), both the first threaded pusher and the second threaded pushers 162a, b move outwards away from the gearing assembly housing 127. For example, the first threaded pusher 162a extends out of a first aperture of the gearing assembly housing 127. Similarly, the second threaded pusher 162b extends out of a second aperture of the gearing assembly housing 127. Movement of the first and second pushers 162a, b will tend to allow the wheel trap 101 to un-grip a trapped wheel 122. Similarly, when the gearing assembly handle 122 is rotated in a second desired direction (i.e., a counterclockwise direction), both the first and second threaded pushers 162a, b move towards or back into the gripper housing 127. This second type of movement of the first and second threaded pushers will therefore allow the plate assemblies to grip the trapped wheel 180 as illustrated n FIG. 6.

In order to tighten the curved plates 105 and 107 on the wheel 180, the handle 122 is first rotated in the clockwise direction. Such an action tends to pull the first and second plate assemblies 100a, b apart from one another and fitting on the wheel 180. Subsequently, the handle 122 is rotated in the anticlockwise direction to grip the vehicle wheel 180. The torque on the handle 122 may then be released and both the first and the second threaded shafts (i.e., the left threaded shaft and the right threaded shaft) 162a, b will move and therefore tend to pull the two curved plate assemblies 100a and 100b, towards the vehicle wheel 180.

As a result, the curved plates 105 and 107 as illustrated in FIG. 6 are pressed against the tread of the wheel 180 by the tension of the threaded shafts 118a, b, so that the curved plates 105 and 107 can no longer be freely moved with respect to the wheel 180. In the case of very strong movements there is nevertheless a possibility that one of the first or second plate assemblies 100a and 100b, becoming detached from the tread of the wheel 180 temporarily, in spite of the tension of the threaded pushers 162a, b, but due to the thrust of the vehicle wheel 180, and the friction coefficient with the ground, the curved plates 105 and 107, will be pressed back against the tread of the wheel 180 by the tension of the threaded pushers 162a, b in that case.

Therefore, it is unlikely that one of the two plate assemblies 100a and 100b, or even the entire wheel trapper 101, to lose contact with the tread of the wheel 180 as a result of being displaced sideways with respect to the wheel 180. With the wheel trap assembly 101, the first and second plate assemblies 100a and 100b, will not be able to move apart, due to the tension of the threaded pushers 118a, b, which might create a clearance between the tread 180 and one of the curved plates and which might lead to the wheel 180 driving over one of the two curved plates 105 and 107, by “taking a run up”.

### Alternative Gearing Assembly

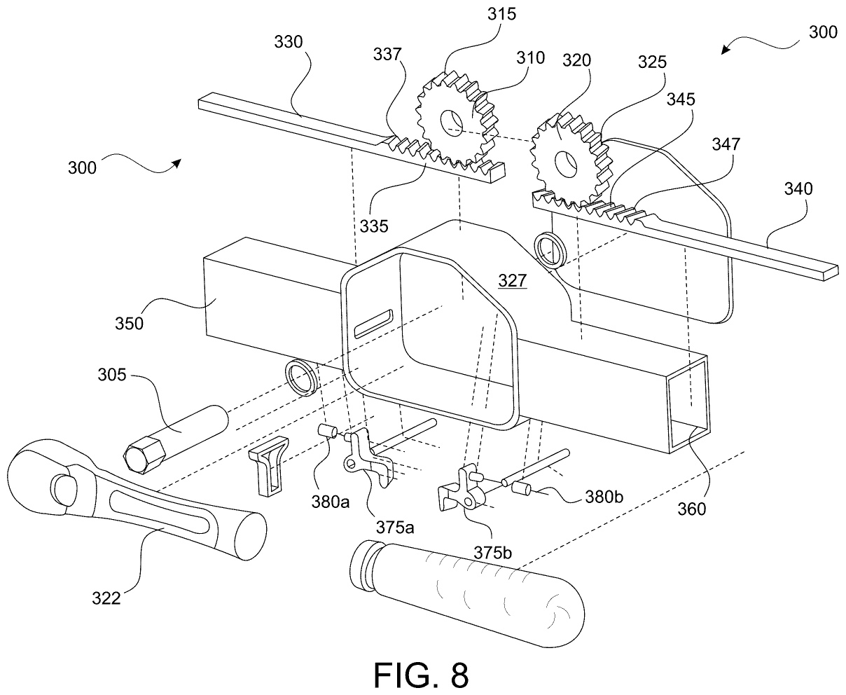

FIG. 8 illustrates an exploded view of an alternative gear assembly 300 for use with a wheel trap, such as the wheel trap 101 illustrated in FIG. 1. As illustrated in FIG. 8, this alternative gear assembly 300 along with a central gripper box 327 of the wheel trapper 101 serves as a mechanism for controlling the gripping and releasing actions of the curved plate assemblies 100a, b, which secure the tire and as illustrated in FIG. 6. In this alternative preferred arrangement, the gearing assembly 300 is operable to move the first plate assembly 100a with respect to the second plate 100b so that a first surface 14a of the first plate assembly 100a engages a first portion of a wheel or a tire.

In one preferred arrangement, this gripper box 327 comprises a dual rack-and-pinion system 325. In this preferred arrangement, the dual rack-an-pinion system 325 is designed for synchronized, precise, and opposing motion of two racks. That is, the first or left sided rack 330 and the second or right sided rack 340. The dual rack-and-pinion mechanism 325 is advantageous for several reasons. For example, this mechanism 325 is compact yet highly efficient, enabling smooth operation of the wheel trap 101.

The gearing assembly 300 comprises a plurality of operably coupled component parts. For example, the gearing assembly 300 comprises a central shaft 305. In this illustrated arrangement, the central shaft 305 comprises a uniform cylindrical shaft this is operably coupled to the gripper handle 322. In this illustrated arrangement, the uniform cylindrical shaft 305 is directly operably coupled to the gripper handle 322. However, as those of ordinary skill in the art will recognize, alternative directly coupled and/or indirectly coupled cylindrical central shaft 305 configurations may be utilized as well.

In operation, an operator of the wheel trap 101 uses the gripper handle 322 to control the operation of the gearing mechanism 300. For example, operably coupled or mounted on this central shaft 305 are one or more pinions. In this illustrated arrangement, there are two pinions 310, 320 that are operably coupled to the central shaft 305. The plurality of pinions comprise a first pinion or a left-hand or left-sided pinion 310 and a second pinion or a right-hand or right-sided pinion 320. In one preferred arrangement, the first pinion 310 and the second pinion 320 comprise substantially similar geometrical configurations. However, as those of ordinary skill the art will recognize, alternative pinion geometrical configurations may be utilized as well.

The first pinion 310 comprising a first plurality of teeth 315 and the second pinion 320 comprising a second plurality of teeth 325 are operatibly configured so that they rotate in the same direction. The first pinion 310 and the second pinion 320 are meshed with two helical racks 330, 340, respectively. The two helical tracks are housed in part inside the gripper box 327.

For example, and as illustrated in FIG. 8, the first pinion 310 is meshed with a first helical rack 330 and the second pinion 320 is meshed with a second helical rack 340. Specifically, a first end 335 of the first helical rack 330 is meshed with the first pinion 310. More specifically, in this rack and pinion system 300, the plurality of first teeth 315 of the first pinion 310 engage a plurality of teeth 337 located near the first end 335 of the first helical rack 330. This set of a plurality of teeth 315, 337 mesh together so as to convert rotational motion of the first pinion into linear motion of the first helical rack.

Similarly, a first end 345 of the second helical rack 340 is meshed with the second pinion 320. Specifically, a first end 345 of the second helical rack 340 is meshed with the second pinion 320. More specifically, in this rack and pinion system 300, the plurality of second plurality of teeth 325 of the second pinion 320 engage a plurality of teeth 347 located near the first end 345 of the second helical rack 340. This set of a plurality of teeth 325, 347 mesh so as to convert rotational motion of the second pinion 320 into linear motion of the second helical rack 340. As those of ordinary skill in the art will recognize, alternative rack and pinion systems and configurations may be utilized as well.

The gearing mechanism 300 further comprises a first and a second pivoting members 375a, b. In one preferred arrangement, the first and second pivoting members 375a, b comprise spring enabled pivoting members. These springs 380a, b allow the spring enabled pivoting members 375a, b to pivot from a first position to a second position, engaging the teeth of various portions of either the first rack 330 or the second rack 340.

For example, each pivoting member 375a, b will comprise a spring that enables the pivoting member to pivot from a first engaging position to a second engaging position. For example, the first pivoting member 375a comprises a first spring 380a and the second pivoting member 375b comprises a second spring 380b. In this manner, when the first rack 330 is moved, the first pivoting member 375a will engage the teeth 337 of the first rack 330 at a first location and then at a subsequent second position. Similarly, when the second rack 340 is moved, the second pivoting member 375b will engage the teeth 347 of the second rack 340 at a first location and then at a subsequent second position.

As also illustrated in FIG. 8, both the first helical rack 330 and the second helical rack 340 are housed inside the gripper box 327. Each of the first and second helical racks 330, 340 extend out an aperture of the gripper box 327. For example, the first helical rack 330 extends out a first aperture of the gripper box 327 and the second helical rack 340 extends out a second aperture of the gripper box 327. More specifically, a second end of the first helical rack 330 extends out the first aperture of the gripper box 327 and a second end of the second helical rack 340 extends out the second aperture of the gripper box 327.

The second end of the first helical rack 330 and the second end of the second rack 340 are both mechanically linked to the curved plate assemblies, as these curved plate assemblies are positioned on either side of the tire as illustrated in FIG. 6. When the operator turns the gripper handle 322 in a first direct (e.g., in a clockwise direction), the central shaft 305 rotates. Rotation of this central shaft 305 causes the left-hand and right-hand pinions 310, 320 to engage their respective racks 330, 340.

That is, rotation of the first pinion 310 engages the first rack 330 and the second pinion 320 engages the second rack 340. This leads to a substantially synchronized motion between the first rack 330 and the second rack 340. This synchronized motion moves the left rack or the first rack 330 to the right or in the direction into the gripper box 327. Similarly, this synchrinized motion moves and the second rack or the right rack 340 to the left or in the direction into the gripper box 327. As a consequence of this substantially synchronized rack and pinion motion, the curved plate assemblies are pulled inward towards one another.

This inward movement of the first rack 330 and the second rack 340 lets the plate assemblies grip the tire, ensuring secure engagement and as illustrated in FIG. 6. The shaft and pinion system 325 reverse their motion when the gripper handle 322 is rotated in a second or opposite direction (i.e, a counterclockwise direction).

In such a situation, the first rack or the left rack 330 moves to the left or away from the gripper box 327. Similarly, the second rack or the right rack 340 moves to the right or away from the gripper box 327. These first and second rack movements push the curved plate assembly's outward, away from one another and away from the gripper box 327. This action loosens the grip on the tire, allowing for plate assembly movements that thereby release the trapped or secured tire.

One advantage of this disclosed gearing arrangement illustrated in FIG. 8 is that it helps to ensure a balanced and controlled motion. This can minimize stress on the components of the wheel trap 101 and can also provide consistent operation of the wheel trap 101. This illustrated dual rack-and-pinion configuration 325 also can help to guarantee that the first rack 330 and the second rack 340 move substantially evenly when either expanding the wheel trap 101 or in collapsing the wheel trap 101. This helps to enable that the curved plates apply a generally uniform pressure on the tire. This generally uniform pressure can be advantageous as it helps to prevent slippage and enhances the safety and reliability of the wheel trap 101 during installation and/or operation. Other advantages and features of the disclosed wheel trap 101 will be evident to those of ordinary skill in the art.

### Alternative Gear Assembly

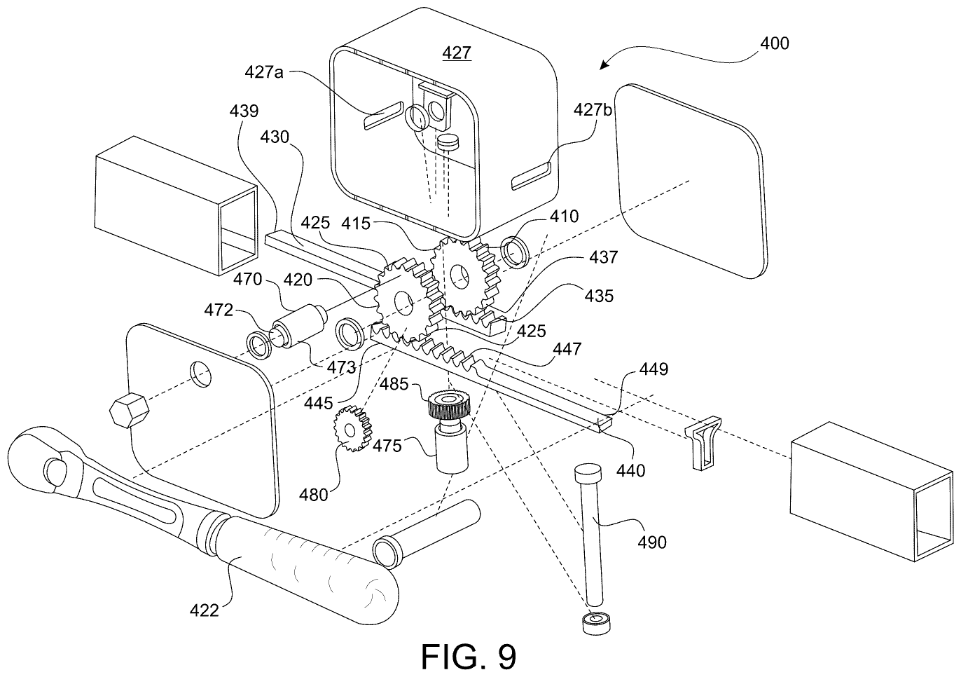

FIG. 9 illustrates an exploded view of an alternative gear assembly 400 for use with a wheel trap, such as the wheel trap 101 illustrated in FIG. 1. As illustrated in FIG. 9, this alternative gear assembly 400 along with a central gripper box 427 of the wheel trapper 101 serves as a mechanism for controlling the gripping and releasing actions of the curved plate assemblies 100a, b, which secure the tire and as illustrated in FIG. 6. In this alternative preferred arrangement, the gearing assembly 400 is operable to move the first plate assembly 100a with respect to the second plate 100b so that a first surface 14a of the first plate assembly 100a engages a first portion of a wheel or a tire.

The gear assembly 400 comprises a plurality of operably coupled component parts. For example, as illustrated in FIG. 9, this alternative gear assembly 400 comprises a handle 422, a first pinion 410, a second pinion 420, a first worm drive 470, a second worm drive 475, a first gear 485, a second gear 480, a first rack or left rack 430, and a second rack or right rack 440.

In this illustrated alternative gear assembly, the alternative gear assembly 400 can operate as follows. First, the depicted gear assembly embodiment 400 leverages a multi-stage gear system to achieve enhanced motion transfer. Another perceived advantage of this alternative gear assembly 400 is that it is configured to overcome a lack of self-locking in certain standard rack-and-pinion systems.

In one preferred arrangement, the geometrical configuration of the first pinion 410 is substantially similar to the geometrical configuration of the second pinion 420. For example, the first pinion 410 comprises a first plurality of teeth 415 and the second pinion 420 comprises a second plurality of teeth 425. In one preferred arrangement, the first pinion 410 and the second pinion 420 are operably configured so that they rotate in the same direction. The first pinion 410 and the second pinion 420 are meshed with two helical racks 430, 440, respectively. The two helical racks 430, 440 are housed in part inside the gripper box 427.

For example, and as illustrated in FIG. 9, the first pinion 410 is meshed with a first helical rack 430 and the second pinion 420 is meshed with a second helical rack 440. Specifically, a first end 435 of the first helical rack 430 is meshed with the first pinion 410. More specifically, in this rack and pinion system 400, the plurality of first teeth 415 of the first pinion 410 engage a plurality of teeth 437 located near the first end 435 of the first helical rack 430. This set of a plurality of teeth 415, 437 mesh so as to convert rotational motion of the first pinion 420 into linear motion of the first helical rack 430.

Similarly, the second helical rack 440 is meshed with the second pinion 420. Specifically, a first end 445 of the second helical rack 440 is meshed with the second pinion 420. More specifically, in this rack and pinion system 400, the second plurality of teeth 425 of the second pinion 420 engage a plurality of teeth 447 located near the first end 445 of the second helical rack 440. This set of a plurality of teeth 425, 447 mesh to convert rotational motion of the second pinion 420 into linear motion of the second helical rack 440. As those of ordinary skill in the art will recognize, alternative rack and pinion systems and configurations may be utilized as well.

As also illustrated in FIG. 9, both the first helical rack 430 and the second helical rack 440 are housed inside the gripper box 427. Each of the first and second helical racks 430, 440 extend out an aperture of the gripper box 427. For example, the first helical rack 430 extends out a first aperture 427a of the gripper box 427. In a substantially similar manner, the second helical rack 440 extends out a second aperture 427b of the gripper box 427. More specifically, a second end 439 of the first helical rack 430 extends out the first aperture of the gripper box 427. And more specifically, a second end 449 of the second helical rack 440 extends out the second aperture 427b of the gripper box 427. As those of ordinarly skill in the art will recognize, alternative gripper box 427 configurations may be utilized as well.

In one preferred arrangement, the second end 439 of the first helical rack 430 and the second end 449 of the second rack 440 are both mechanically linked to the curved plate assemblies, as these curved plate assemblies are positioned on either side of the tire as illustrated in FIG. 6. As such, with such a preferred arrangement, when the operator turns the gripper handle 422 in a first predetermined or predisried directtion (e.g., in a clockwise direction), and as described in detail herein, the first worm drive 470 rotates. As the first worm drive 470 rotates, the various operably coupled component parts of the gear assembly 400 cooperate with one another. In this manner, these operably coupled component parts cooperate with one another so that rotation of this first worm drive causes the left-hand and right-hand pinions 410, 420 to engage their respective racks 430, 440.

For example, operation of the gear assembly 400 is configured to begin with the user manually turning the handle 422. In this illustrated assembly 400, the handle 422 is operably coupled to a shaft 472. It is this shaft 472 that is operably coupled to the first worm gear drive 470. In one arrangement, this shaft 472 and the first worm gear drive 470 comprise a unitary structure. However, as those of ordinary skill in the art will recognize, alternative shaft and worm gear drive configurations may be utilized as well. As just one example, the shaft 472 may comprise a separate and independent component part than the first worm drive 470.

This first worm gear drive 470 is provided with a thread 473 and this thread is provided along an outer surface of the first worm gear drive 470. In one preferred arrangement, this first worm gear drive thread 473 that is provided along the outer surface of the first worm gear drive 470 comprises a helical thread. However, as those of ordinary skill in the art will recognize, alternative thread configurations and first worm gear drive 470 geometries may be utilized as well.

The operating handle 422 serves as the primary interface for the user operating the wheel trap 101, initiating motion of the gear assembly 400 when rotated. This rotational motion of the operating handle 422 is transmitted to the first worm gear drive 470, and it is this first worm gear drive 470 that is operably coupled directly to the operating handle 422. The first worm gear drive 470, in turn, drives the first gear 485. Moreover, since in this illustrated arrangement the second worm gear drive 475 is mounted on the same shaft as the first gear 485, the rotation is further transferred to the second worm gear drive 475. In addition, since the second worm gear drive 475 is operatively coupled to the second gear 480, this completes the transfer of motion.

The inclusion of the first worm gear drive 470 and the second worm gear drive 475 in the gear assembly 400 introduces certain advantages. As just one example, inclusion of the first worm gear drive 470 and the second worm gear drive 475 in the gear assembly 400 introduces a self-locking capability. Unlike certain traditional rack-and-pinion mechanisms, the first and second worm gear drives 470, 475 prevent unintended motion under external forces, helping to ensure safety and stability during operation. As those of ordinary skill in the art will recognize, the first worm gear drive 470 and the second worm gear drive 475 in the gear assembly 400 introduce other advantages as well.

In the gear assembly 400, the second gear 480 is mounted or positioned on the same shaft as the first pinion 410 and the second pinion 420. These pinions 410, 420, comprise slanted teeth and these slanted teeth provided certain advantages. For example, the slanted teeth characteristic of helical gears, are coupled to the left and right racks, respectively. Therefore, when the operating handle 422 is rotated inn a desired operating direction (e.g., in a clockwise operating direction), the first rack or left rack 430 and second rack or right rack 440 move inward towards the gear assembly 300 or rather towards the gripper box 427.

Conversely, a second direction of the operating handle 422 or a counterclockwise rotation of the operating handle 422 causes the first and second racks 430, 440 to move outward, away from the gear assembly 300 or away from the gripper box 427. The slanted teeth of the the first and second pinions 410, 420 can play an important role in ensuring smooth and synchronized motion of the first and second racks 430, 440. Unlike straight-cut teeth found in certain spur gears, the slanted teeth provide gradual engagement, reducing abrupt contact and minimizing vibrations. Such a slanted teeth configure results in quieter operation and a smoother mechanical response, making the gear assembly 400 more efficient and user-friendly.

The slanted teeth design feature also offers a larger contact area between the first pinion and the second pinion 410, 420 and the first and second racks 430, 440, respectively. This distributes the load more evenly across the slanted teeth, which provides certain advantages. For example, distributing the load mor evenly can reduce localized wear and enhancing the overall durability of the system. Additionally, the opposite slanting of the teeth in the first and second pinions 410, 420 can also in certain situations help to ensure synchronized movement of the first and second racks 430, 440. For example, as the operating handle 422 is rotated in a certain desired direction (e.g., in a clockwise direction), the first pinion 410 engages the first rack 430 to pull this first rack 430 inward, while the second pinion 420 engages the second rack 440 in a substantially similar manner. This synchronization between the first rack 430 movement and the second rack 440 movement can be important for maintaining balance and precision during operation of the wheel trap 101.

The integration of helical gears, such as the slanted pinions 410, 420, is not only for smoother operation but also to complement the self-locking feature of the worm gears. Helical gears as herein described and illustrated transmit more torque than spur gears of similar size and help eliminate backlash, thereby helping to ensure that the first and second racks 430, 440 remain in their respective positions when subjected to external forces. This feature can be important in applications where precision and safety are important. The smooth meshing of the slanted teeth with the first and second racks 430, 440 also tends to reduce noise and vibration, adding to the refined operation of the wheel trap system 101.

Combining a plurality of worm gears, such as the first and second worm gear drives 470, 475 for self-locking and helical gears for smooth motion tends to ensure a reliable, efficient, and durable system.

### Stowable/Folded Position

FIG. 5 illustrates a perspective view of the wheel trap 101 in a stowable position. To achieve this stowable position, in one preferred arrangement, the first sliding housing 116a and the second sliding housing 116b are moved from a first position (FIG. 1) to a second position (FIG. 5). In the final folded position, the first and second plate assemblies 100a, b reside adjacent one another so that both the first bracing assembly and the second bracing assembly 30a, b reside in a generally vertical position. In this generally vertical position, both the first plate assembly 100a and the second plate assembly 100b are now facing in the same direction as illustrated in FIG. 5.

As can be seen from FIG. 5, a carrying handle 105a can be provided and removably operably coupled by way of a snap lock at one end to the back of the second plate assembly 100b. As second end of the carrying handle 105b can then be removably operably coupled to a back of the first plate assembly 100a. The folded wheel trap 101 may then be carried from one location to a second location my use of the carry handle 105. One purpose of foldability assembly is to make the wheel trap 101 compact for storage in the boot or trunk of a vehicle.

### In Use

The wheel trap embodiments described and illustrated herein may be used to immobilize or secure a suspect vehicle. When a suspect vehicle is to be immobilised or trapped, for example by law enforcement personel or policemen on the road, the wheel trap is taken out of the vehicle boot in the stowable state (see FIG. 5) by the law enforcement personel or policemen. The wheel trap 101 is then unfolded by operating both the first and the second pushbutton 151a, b of the first and second bracing assemblies 30a, b, respectively. Operation of the first and second pushbuttons 151a, b as herein described in detail allows the slidable housings to slide outwardly, away from the gearing assembly housing structure.

The wheel trap 101 is then moved towards the wheel 180 from the outer side of the vehicle. The first plate assembly and the second plate assembly 100a, b are then screwed slightly apart by the action of the gear assembly handle 122. One preferred method of moving these plate assemblies 100a, b apart is described herein in detail. However, as those of ordinary skill in the art will recognize, alternative methods for such separation may be utilized as well. As just one example, an automatic mechanism may be utilized to move these plate assemblies 100a, b apart from one another.

The wheel trap assembly 101 comprising the first and second plate assemblies 100a, b, the first and second brace assemblies 30a, b, and the gearing assembly 40, are then positioned over the wheel. Movement of these various wheel trap assembly components is then undertaken until the bracing assemblies 30a, b are in contact or nearly in contact with the side of the wheel 180 as illustrated in FIG. 6.

Following this positioning step, the gear assembly handle 122 of the gearing assembly 40 is then tightened as described in detail herein. Tightening of the gearing assembly 40 allows the first plate assembly 100a and the second plate assembly 100b to grip the wheel 180 outer portions or the wheel treads. As a result, the first and second plate assemblies 100a, b are pressed against the tread of the wheel 180 by the pushing force of the handle 122 and hence the spiral gear and spiral pinion combination, so that they can no longer be freely moved with respect to the wheel 180. This procedure may be repeated for one or more of the other wheels of the vehicle. However, in one preferred wheel trap embodiment, only one wheel trap 101 may be required to immobilize a vehicle.

The wheel trap 101 may be used in various environmental conditions. As just one example, in the scenario where the pavement or road or the underlying material on which the wheel trap 101 is placed is slippery or if the underlying material or the road is inclined on which the wheel 180 and the curved plate assemblies 100a, b are rested on a wet or inclined supporting surface (a road or street), there will be a natural tendency of the wheels to roll. In this situation, the curved plates will be held in contact with the tread of the wheel 180 by the gripping force of the gear assembly 40.

In addition, the curved plates will be held firmly on the surface by means of a driving force transferred to the surface and coefficient of friction plate under the base of the curved plate and in contact with the surface. In one preferred arrangement, the driving force shall be transferred to the supporting surface by means of brace concept used in the curved plate which changes the direction of the horizontal force towards the road thus aiding the device to stand firmly on the road without slipping.

Therefore, the vehicle wheel tread is gripped tightly to the curved plates. As described in detail herein, the first and second plate assemblies 100a, b are rigidly structured with base frictional plates. The vehicle torque assists the gripping further by transferring the vehicle torque to the supporting surface due to the peculiar structure of the first plate assembly 100a and the second plate assembly 100b. Therefore, it is difficult for one of the two curved plates, or even the entire trapper assembly, to lose contact with the tread of the wheel because of being gripped on the wheel through brace assembly and because of being gripped from the rear side of the wheel by means of the gearing assembly 40.

With the wheel trap assembly 101, the curved plates will not be able to move apart, due to the gripping force of the handle gearing assembly, which might try to create a clearance between the tread and one of the curved plates and which might lead to the wheel driving over one of the two curved plates by taking a run up.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. A wheel trap apparatus comprising:
a first plate assembly;
a second plate assembly;
a first brace assembly operably coupled to a first portion of the first plate assembly and operably coupled with a second portion of the first plate assembly;
a second brace assembly operably coupled to a first portion of the second plate assembly and operably coupled to a second portion of the second plate; and
a gear assembly operable to move the first plate assembly with respect to the second plate assembly so that
a first surface of the first plate assembly engages a first portion of a wheel and
a second surface of the second plate assembly engages a second portion of a wheel.

2. The wheel trap apparatus of claim 1 wherein
the first brace assembly is pivotally engaged with the first portion of the first plate assembly and pivotally engaged with the second portion of the first plate assembly.

3. The wheel trap apparatus of claim 1 wherein
the first plate assembly comprises a first curved plate.

4. The wheel trap apparatus of claim 1 wherein
the first plate assembly comprises a second curve plate.

5. The wheel trap apparatus of claim 1 wherein
the first brace assembly comprises a telescopic assembly, the telescopic assembly comprising a first bracing member telescopically engaged with a second bracing member.

6. The wheel trap apparatus of claim 1 wherein
the gear assembly is operably coupled to the first brace assembly and the second brace assembly.

7. The wheel trap apparatus of claim 6 wherein
the gear assembly comprises a gearing assembly handle.

8. The wheel trap apparatus of claim 7 wherein
the gear assembly handle is operable to move the first plate assembly with respect to the second plate assembly.

9. The wheel trap apparatus of claim 6 wherein
the gear\ assembly comprises a worm gear assembly.

10. The wheel trap apparatus of claim 6 wherein
the gear assembly comprises a rack and pinion assembly.

11. The wheel trap apparatus of claim 1, wherein
the first curved plate is pivotally hinged to the second curved plate.

12. The wheel trap apparatus of claim 10, wherein
the first plate assembly comprises a third curved plate.

13. The wheel trap apparatus of claim 10, wherein
the third curved plate comprises a stationary curved plate.

14. The wheel trap apparatus of claim 1 wherein
the first brace assembly comprises a first male telescoping cylinder engaged with a first female telescoping cylinder.

15. The wheel trap apparatus of claim 14 wherein
the first male telescoping cylinder is spring biased within the first female telescoping cylinder.

16. The wheel trap apparatus of claim 14 wherein
the first brace assembly comprises a second male telescoping cylinder engaged with a second female telescoping cylinder.

17. The wheel trap apparatus of claim 14 wherein
the first brace assembly further comprising a first pushbutton assembly.

18. The wheel trap apparatus of claim 17 wherein
operation of the first pushbutton assembly enables the first male telescoping cylinder to rotate with respect to the first brace assembly.

19. The wheel trap apparatus of claim 1 wherein
the first plate further comprises a first high friction layer.

20. The wheel trap apparatus of claim 1 wherein
the first plate assembly further comprises a foldable first plate.
